(19) United States
(12) Patent Application Publication
(10) Pub. No.: US 2007/0203280 A1
(43) Pub. Date: Aug. 30, 2007

(54) Method for manufacturing water-absorbing resin composition and water-absorbing resin composition

(76) Inventor: Hiroko Okochi, Himeji-shi (JP)

Correspondence Address: HARNESS, DICKEY & PIERCE, P.L.C., P.O. BOX 8910, RESTON, VA, 20195, US

(21) Appl. No.: 11/449,666

(22) Filed: Jun. 9, 2006

(30) Foreign Application Priority Data
Feb. 24, 2006 (JP) 2005-049584

(51) Int. Cl. C08K 3/22

(52) U.S. Cl. 524/430; 524/493; 524/431

(57) ABSTRACT

As water-absorbing resin materials used, for example, as water-absorbing materials of paper diapers, the present invention realizes a water-absorbing resin composition whose basic water-absorbing performances, productivity, etc. are not spoiled but whose liquid diffusibility that is a practically important characteristic is improved drastically. A method for manufacturing the water-absorbing resin composition of the present invention includes the step of mixing the water-absorbing resin A and the inorganic fine particle B, which has been irradiated with ultraviolet rays, on condition that the amount of the inorganic fine particle B is from 0.01 part by weight to 10 parts by weight when the amount of the water-absorbing resin A is 100 parts by weight. Thus, it is possible to manufacture the water-absorbing resin composition whose liquid distribution velocity (LDV) is from 2.0 mm/s to 10 mm/s.

### FIELD OF THE INVENTION

The present invention relates to a method for manufacturing a water-absorbing resin composition and the water-absorbing resin composition, and more particularly to a method for manufacturing the water-absorbing resin composition used as, for example, a water-absorbing material of a paper diaper, and the water-absorbing resin composition obtained by this method.

### BACKGROUND OF THE INVENTION

It is well-known that a polymer bead with high water absorbability or a water-absorbing resin particle is used as a water-absorbing material used in a paper diaper, etc.

The water-absorbing resin particle for use in such application needs to have a large capacity of water absorption and a high speed of water absorption. In addition to these basic characteristics, another important characteristic is liquid diffusibility.

The liquid diffusibility is such a characteristic that, when the water-absorbing resin particles are used as the water-absorbing material of the paper diaper, etc., liquid (for example, urine) diffuses rapidly on the surfaces of the water-absorbing resin particles and into spaces between the water-absorbing resin particles. When the liquid diffuses into a wide range, a contact area between the liquid and the water-absorbing resin particles increases, so that the liquid is easily absorbed by the water-absorbing resin particles. If two kinds of water-absorbing resin particles have a similar capacity of water absorption and a similar speed of water absorption, the water-absorbing resin particle having higher liquid diffusibility has higher water-absorbing performance. For example, if the urine stays localized for a long time in a water-absorbing product (for example, the paper diaper) which contacts a human skin, this causes discomfort. However, if the urine diffuses into a wide range, such discomfort decreases.

Various conventional techniques have been proposed for improving the liquid diffusibility of the water-absorbing resin composition.

For example, disclosed is a technique for obtaining a water-absorbing agent, having high liquid permeability, high capillary suction and excellent liquid diffusibility, by mixing the water-absorbing resin particles with, for example, hydrophilic amorphous silica particles as a liquid permeability improver (for example, see Patent Document 1).

Moreover, another well-known technique is that the water-absorbing resin particle is irradiated with active energy rays such as electron rays and/or radiation rays for improving the performances of the obtained water-absorbing resin particle.

For example, disclosed is a technique for improving a water absorption ratio, etc. by irradiating specific water-absorbing resin particles with the electron rays or the radiation rays having a specific intensity (for example, see Patent Document 2).

The conventional techniques for improving the liquid diffusibility of the water-absorbing resin particle cannot obtain an adequate performance.

For example, it is impossible to adequately improve the liquid diffusibility only by mixing the water-absorbing resin particles with inorganic particles, as in the technique of Patent Document 1. Moreover, the water absorption ratio may improve by irradiating the water-absorbing resin particles with the active energy rays, as in Patent Document 2. However, the liquid diffusibility does not improve in this case.

By variously changing the choice of the monomer and the settings of polymerization conditions when manufacturing the water-absorbing resin particle, it may be possible to improve the liquid diffusibility of the water-absorbing resin particle. However, this makes it difficult to manufacture the particle, and increases a manufacturing cost. Although the liquid diffusibility improves, the other characteristics such as the amount of water absorption and an absorption ratio under pressure reduce, resulting in low practicality.

An object of the present invention is to drastically improve the liquid diffusibility, which is a practically important characteristic, of the water-absorbing resin material (used as, for example, the water-absorbing material of the paper diaper), without spoiling the basic water-absorbing performances, the productivity, etc.

Patent Document 1

Japanese Unexamined Patent Publication No. 261797/2004 (Tokukai 2004-261797)

Patent Document 2

Japanese Unexamined Patent Publication No. 129232/1984 (Tokukaisho 59-129232)

### DISCLOSURE OF INVENTION

In order to solve the above-described problems, a method for manufacturing a water-absorbing resin composition of the present invention includes the step of mixing a water-absorbing resin A and an inorganic fine particle B, which has been irradiated with ultraviolet rays, on condition that an amount of the inorganic fine particle B is from 0.01 part by weight to 10 parts by weight when an amount the water-absorbing resin A is 100 parts by weight.

In order to solve the above-described problems, a method for manufacturing a water-absorbing resin composition of the present invention includes the steps of: mixing a water-absorbing resin A and an inorganic fine particle B on condition that an amount of the inorganic fine particle B is from 0.01 part by weight to 10 parts by weight when an amount of the water-absorbing resin A is 100 parts by weight, to produce a mixture; and irradiating the mixture of the water-absorbing resin A and the inorganic fine particle B with ultraviolet rays.

In the method for manufacturing the water-absorbing resin composition of the present invention, it is preferable that the irradiating step be carried out after water is added to the composition, an amount of the water being from 0.1% by weight to 5% by weight with respect to a total amount of the water-absorbing resin composition.

Moreover, in the method for manufacturing the water-absorbing resin composition of the present invention, it is preferable that the inorganic fine particle B be an inorganic metal oxide.

Moreover, in the method for manufacturing the water-absorbing resin composition of the present invention, it is preferable that the ultraviolet rays irradiation be irradiation, for 1 second to 60 minutes, of rays which contain an ultraviolet region of wavelength 200 nm to 400 nm, an irradiation dose of which is 100 mJ/cm² to 10,000 mJ/cm², and an irradiation intensity of which is 1 mW/cm² to 1,000 mW/cm².

Moreover, in the method for manufacturing the water-absorbing resin composition of the present invention, it is preferable that the water-absorbing resin A be water-absorbing resin particles having a mass average particle diameter ranging from 100 μm to 1,000 μm.

In order to solve the above-described problems, a water-absorbing resin composition of the present invention includes a water-absorbing resin A and an inorganic fine particle B, and has a liquid distribution velocity (LDV) of 2.0 mm/s to 10 mm/s.

In the water-absorbing resin composition of the present invention, it is preferable that the inorganic fine particle B have been irradiated with ultraviolet rays.

Moreover, in the water-absorbing resin composition of the present invention, it is preferable that the inorganic fine particle B be an inorganic metal oxide.

Moreover, in the water-absorbing resin composition of the present invention, it is preferable that the inorganic fine particle B be a mixture of two or more kinds of inorganic metal oxides.

Moreover, in the water-absorbing resin composition of the present invention, it is preferable that the mixture of two or more kinds of inorganic metal oxides be a mixture containing silica and titanium oxide.

By the method for manufacturing the water-absorbing resin composition of the present invention, it is possible to obtain the water-absorbing resin composition (i) containing the water-absorbing resin A and the inorganic fine particle B which has been subjected to an ultraviolet rays irradiation treatment and (ii) having a dramatically excellent liquid diffusibility (LDV).

Even if the inorganic fine particle B itself does not have the water-absorbing property, and the water-absorbing resin A itself is made of a normal material and manufactured by a normal manufacturing technology, the combination of the water-absorbing resin A with the inorganic fine particle B which has been irradiated with ultraviolet rays dramatically improves the LDV as compared with the mixture of the water-absorbing resin A and the inorganic fine particle B, or the water-absorbing resin A which has been subjected to the ultraviolet rays irradiation treatment. In addition, the combination of the water-absorbing resin A with the inorganic fine particle B which has been irradiated with ultraviolet rays improves the LDV dramatically, but does not spoil the basic water-absorbing performances, such as the absorption ratio (CRC), the absorption ratio under pressure (AAP), etc. Therefore, the combination of the water-absorbing resin A with the inorganic fine particle B which has been irradiated with ultraviolet rays can achieve practically enough performance.

Since the combination of the water-absorbing resin A with the inorganic fine particle B which has been irradiated with ultraviolet rays can achieve the drastic improvement of the LDV without spoiling the other absorption performances, the combination is extremely useful as the water-absorbing material of, for example, the paper diaper which needs to rapidly absorb the liquid such as the urine. If the paper diaper which contacts a human skin can rapidly absorb the urine, diffuse it into a wide range, and hold it, this gives a human skin dry feeling, and realizes an extremely satisfactory sense of use. Thus, it is possible to dramatically improve not only the absorption performances of the liquid but also practical performances such as the sense of use.

The water-absorbing resin composition can be manufactured easily and efficiently with a comparatively simple device by carrying out a normal water-absorbing resin manufacturing technique, with just an addition of the inorganic fine particle, or the ultraviolet rays irradiation treatment. When manufacturing the water-absorbing resin, it is not necessary to use a special material or to adopt a special manufacturing method. As a result, it is possible to provide the water-absorbing resin composition, the productivity of which is high and economical, and the performance quality of which is excellent.

### BEST MODE FOR CARRYING OUT THE INVENTION

The following will explain the present invention in detail. However, the scope of the present invention is not limited to explanations below. Other than the following exemplifications, the present invention may be altered within the spirit of the present invention.

In the present invention, (i) “weight” is used as a synonym of “mass”, (ii) “% by weight” is used as a synonym of “% by mass”, and (iii) “major component” is used as a synonym of “a component, the amount of which is 50% by mass or more, preferably 60% by mass or more, further preferably 70% by mass or more, and especially preferably 80% by mass or more”. Moreover, “X to Y” indicating a range denotes “not less than X but not more than Y”.

A method for manufacturing a water-absorbing resin composition of the present invention includes one of the following steps (I) and (II).

(I) A step of mixing a water-absorbing resin A with an inorganic fine particle B which has been irradiated with ultraviolet rays

(II) A step of irradiating a mixture of the water-absorbing resin A and the inorganic fine particle B with ultraviolet rays

The water-absorbing resin composition of the present invention is obtained preferably by the above-described manufacturing method as an example, contains the water-absorbing resin A and the inorganic fine particle B, and has a liquid distribution velocity (LDV) of 2.0 mm/s to 10 mm/s.

Performance Evaluation of Water-Absorbing Resin Composition

Performances of the water-absorbing resin composition can be evaluated by the following characteristics or measurement values. A specific measurement of each characteristic is carried out by a measurement method defined in the following “Examples”. In the present specification, the term “water-absorbing (water absorption)” in “water-absorbing property”, “water absorption ratio”, “water-absorbing performance”, etc. means an absorption of not only water but also saline solution, urine, and other kinds of liquids.

Liquid Distribution Velocity (LDV): This indicates a velocity of a liquid diffusing in an absorber, and especially relates to an initial velocity of a liquid being absorbed. The larger the value of the LDV is, the more excellent the liquid diffusibility that is an object of the present invention is.

Centrifuge Retention Capacity (CRC): This is also referred to as “an absorption ratio under no pressure”, and indicates the amount of liquid the absorber can absorb, in other words, a basic absorption capacity.

Absorbency Against Pressure (AAP): Similar to CRC, this indicates an absorption capacity, but is the absorption capacity under pressure. This is also referred to as “an absorption ratio under pressure”. This indicates the ability of an absorber product to absorb liquid in a use environment.

Saline Flow Conductivity (SFC): This indicates the level of liquid permeability. This level is shown by how easily a liquid can pass through the swollen water-absorbing resin composition. The larger the value of the SFC is, the more excellent the liquid permeability is.

Water-Absorbing Resin

Basically, a normal water-absorbing resin itself can be used here. The water-absorbing resin used here may be a water-absorbing resin made of a known material and manufactured by adopting a known manufacturing method.

Specifically, examples of the water-absorbing resin are: a water-absorbing resin particle and surface-cross-linking water-absorbing resin particle manufactured by adopting a manufacturing technique described below; water-absorbing resins described in respective documents cited in the present specification; etc.

The water-absorbing resin has various shapes, such as a particle, fiber, sheet, tape and gel. The following will explain a particulate water-absorbing resin, that is, a water-absorbing resin particle. However, the other shape can be used as long as it causes no technical problem.

The water-absorbing resin is a cross-linked polymer which may form hydrogel and has a water-swelling property and a water insolubility. The water-absorbing resin having the water-swelling property is a water-absorbing resin which, in ion-exchange water, absorbs the water five times its own weight at minimum, preferably 50 times to 1,000 times its own weight. The water-absorbing resin having the water insolubility means that an uncross-linked water-soluble component (water-soluble polymer) in the water-absorbing resin is preferably 0% by mass to 50% by mass, more preferably 25% by mass or less, further preferably 20% by mass or less, further preferably 15% by mass or less, and especially preferably 10% by mass or less.

From the aspect of the liquid permeability and a liquid suction property, it is preferable that the water-absorbing resin be a water-absorbing resin having a cross-linked structure obtained by polymerizing an acid group-containing unsaturated monomer.

Used as the acid group-containing unsaturated monomer is such a monomer (such as acrylonitrile) that will have an acid group by hydrolysis carried out after polymerization. However, used as the acid group-containing unsaturated monomer is preferably the acid group-containing unsaturated monomer which contains the acid group during polymerization.

The water-absorbing resin may be one or a mixture of two or more of: a partially neutralized polyacrylic acid polymer; hydrolysate of a starch-acrylonitrile graft polymer; a starch-acrylic acid graft polymer; a saponified vinyl acetate-acrylic ester copolymer; hydrolysate of an acrylonitrile copolymer; hydrolysate of an acrylamide copolymer; their cross-linked products; modified carboxyl group-containing cross-linked polyvinyl alcohol; and a cross-linked isobutylene-maleic anhydride copolymer. The water-absorbing resin is preferably the partially neutralized polyacrylic acid polymer having the cross-linked structure obtained by polymerizing and cross-linking a monomer containing acrylic acid and/or its salt (neutralized product) as the major component.

When a monomer contains acrylic acid and/or its salt as the major component, the other monomer may be used together. Examples are water-soluble or hydrophobic unsaturated monomers, such as methacrylic acid; maleic acid (maleic anhydride); fumaric acid; crotonic acid; itaconic acid; vinyl sulfonic acid; 2-acrylamide (methacrylamide)-2-methylpropanesulfonic acid; acryloxyalkanesulfonic (methacryloxyalkanesulfonic) acid and its alkali metal salt or its ammonium salt; N-vinyl-2-pyrrolidone; N-vinylacetamide; acrylamide (methacrylamide); N-isopropyl acrylamide (methacrylamide); N,N-dimethyl acrylamide (methacrylamide); 2-hydroxyethyl acrylate (methacrylate); methoxypolyethyleneglycol acrylate (methacrylate); polyethylene glycol acrylate (methacrylate); isobutylene; lauryl acrylate (methacrylate); etc.

When using the monomer other than acrylic acid (salt), the amount of the monomer other than acrylic acid (salt) is preferably 0 mole % to 30 mole % with respect to the total amount of acrylic acid and/or its salt used as the major component, and more preferably 0 mole % to 10 mole %. As a result, it is possible to further improve the absorption property of the resulting water-absorbing resin (composition), and also possible to obtain the water-absorbing resin (composition) at low cost.

The cross-linked structure is essential for the water-absorbing resin. The water-absorbing resin may be a self cross-linking type which does not require a cross-linking agent. However, it is preferable that the water-absorbing resin be a water-absorbing resin obtained by copolymerizing or reacting a cross-linking agent (an internal cross-linking agent of the water-absorbing resin) having, in one molecule, two or more polymerizable unsaturated groups, or two or more reactive groups.

Specific examples of the internal cross-linking agent are: N,N′-methylenebis acrylamide (methacrylamide); ethyleneglycol (polyethyleneglycol) diacrylate (dimethacrylate); propyleneglycol (polypropyleneglycol) diacrylate (dimethacrylate); trimethylolpropane triacrylate (trimethacrylate); glycerin triacrylate (trimethacrylate); glycerin acrylate methacrylate; ethylene oxide modified trimethylolpropane triacrylate (trimethacrylate); pentaerythritol hexaacrylate (hexamethacrylate); triallyl cyanurate; triallyl isocyanurate; triallyl phosphate; triallyl amine; polyallyloxyalkane (polymethallyloxyalkane); ethyleneglycol (polyethyleneglycol) diglycidyl ether; glycerol diglycidyl ether; ethylene diamine; ethylene carbonate; propylene carbonate; polyethyleneimine; glycidyl acrylate (methacrylate); and polyhydric (at least dihydric) alcohols such as ethylene glycol, polyethylene glycol, propylene glycol, glycerin, pentaerythritol, xylitol, and sorbitol.

These internal cross-linking agents may be used alone or in combination of two or more kinds. The internal cross-linking agent may be added to a reaction system at one time or in installments. In the case of using at least one kind of internal cross-linking agent or two or more kinds of internal cross-linking agents, it is preferable that a compound having two or more polymerizable unsaturated groups be necessarily used at the time of polymerization in view of the absorption property, etc. of the resulting water-absorbing resin or water-absorbing resin composition.

The amount of the internal cross-linking agent to be used is in a range preferably from 0.001 mole % to 2 mole % with respect to the amount of the monomer (except the cross-linking agent), more preferably from 0.005 mole % to 1 mole %, further preferably from 0.005 mole % to 0.5 mole %, further preferably from 0.01 mole % to 0.5 mole %, further preferably from 0.01 mole % to 0.2 mole %, especially preferably from 0.03 mole % to 0.2 mole %, and most preferably from 0.03 to 0.15 mole %. When the amount of the internal cross-linking agent to be used is smaller than 0.001 mole %, and when the amount of the internal cross-linking agent to be used is larger than 2 mole %, it may not be possible to obtain a sufficient absorption property(s) (for example, the water-soluble component becomes too much, the water absorption ratio becomes low, etc.).

When introducing the cross-linked structure into a polymer by using the internal cross-linking agent, the internal cross-linking agent may be added to the reaction system before the polymerization of the monomer, during the polymerization, after the polymerization, or after the neutralization.

When polymerizing the monomer to obtain the water-absorbing resin used in the present invention, the bulk polymerization and the precipitation polymerization can be carried out. However, in view of the performance, ease of control of the polymerization, and the absorption property of the swollen gel, it is preferable that the aqueous polymerization and the reversed-phase suspension polymerization be carried out (here, the monomer is aqueous solution).

When the monomer is the aqueous solution (hereinafter referred to as “monomer aqueous solution”), the concentration of the monomer in the aqueous solution is determined depending on the temperature of the aqueous solution, the monomer, etc. and is not especially limited. However, it is preferably in a range from 10% by mass to 70% by mass, and further preferably in a range from 20% by mass to 60% by mass. Moreover, when carrying out the aqueous polymerization, a solvent other than water may be used together according to need, and the kind of the solvent to be used together is not especially limited.

Note that the reversed-phase suspension polymerization is a polymerization method in which the monomer aqueous solution is suspended in a hydrophobic organic solvent. The reversed-phase suspension polymerization is disclosed in, for example, U.S. Pat. Nos. 4,093,776, 4,367,323, 4,446,261, 4,683,274, 5,244,735, etc. The aqueous polymerization is a method for polymerizing the monomer aqueous solution without a dispersing solvent. The aqueous polymerization is disclosed in, for example, U.S. Pat. Nos. 4,625,001, 4,873,299, 4,286,082, 4,973,632, 4,985,518, 5,124,416, 5,250,640, 5,264,495, 5,145,906, and 5,380,808, and European Patent Nos. 0,811,636, 0,955,086, and 0,922,717. In the present invention, the above-described monomers, initiators, etc. are applicable to these polymerization methods.

For initiating the polymerization, it is possible to use (i) a radical polymerization initiator, such as potassium peroxodisulfate, ammonium persulfate, sodium persulfate, t-butyl hydroperoxide, hydrogen peroxide, 2,2′-azobis (2-amidino propane) dihydrochloride and (ii) a photo polymerization initiator, such as 2-hydroxy-2-methyl-1-phenyl-propane-1-one. In view of the physical property, the amount of the polymerization initiator to be used is normally from 0.001 mole % to 2 mole % (with respect to the amount of the entire monomer), and preferably 0.01 mole % to 0.1 mole %.

Normally, obtained after the polymerization is a hydrate gel cross-linked polymer. According to need, this cross-linked polymer is dried, and is crushed before and/or after this drying. Thus, the water-absorbing resin particle is obtained. Moreover, the drying is carried out in a temperature range normally from 60° C. to 250° C., preferably from 100° C. to 220° C., and more preferably from 120° C. to 200° C. A drying time depends on the surface area and water content of the polymer, and the type of a drying machine, and is determined so that the polymer has a desired water content.

Water-Absorbing Resin Particle

If the water-absorbing performance of the water-absorbing resin particle is excellent, the water-absorbing performance of the resulting water-absorbing resin composition is likely to be excellent. The present invention can improve the LDV or the SFC of the water-absorbing resin composition while maintaining high CRC and AAP, and can obtain a high LDV value (for example, 3.0 mm/s or higher) which could not be achieved conventionally. If using the water-absorbing resin particle having excellent CRC, AAP, etc., those performances of the water-absorbing resin composition are also excellent. Needless to say, if the LDV and SFC of the water-absorbing resin particle are excellent, it is possible to further improve the LDV and SFC of the water-absorbing resin composition.

It is preferable that each of the water-absorbing resin particle and the water-absorbing resin composition (will be described later) be adjusted so as to have a specific particle diameter. It is preferable that the amount of particles each having a particle diameter of 150 μm or larger but smaller than 850 μm (defined by sieve classification: JIS Z8801-1:2000) be 90% by mass or more with respect to the whole, it is more preferable that the amount of particles each having a particle diameter of 150 μm or more but smaller than 850 μm be 95% by mass or more with respect to the whole, and it is further preferable that the amount of particles each having a particle diameter of 150 μm or more but smaller than 850 μm be 98% by mass or more with respect to the whole. Moreover, it is preferable that the amount of particles each having a particle diameter of 300 μm or more be 60% by mass or more with respect to the whole. Note that “the whole” used here means “all the water-absorbing resin particles in the water-absorbing resin composition”.

Moreover, a mass average particle diameter (D50) of the water-absorbing resin particles is set to 100 μm to 1,000 μm, preferably 200 μm to 710 μm, more preferably 200 μm to 600 μm, further preferably 300 μm to 600 μm, especially preferably 300 μm to 500 μm, and most preferably 350 μm to 450 μm. Note that the particle diameter of the water-absorbing resin particle may be adjusted by granulation, etc. according to need.

Moreover, a logarithm standard deviation (σξ) of a particle size distribution of the water-absorbing resin particle of the present invention is preferably 0.1 to 0.45, more preferably 0.25 to 0.45, and further preferably 0.30 to 0.40. The smaller the logarithm standard deviation (σξ) of the particle size distribution is, the narrower the particle size distribution is.

Note that “a particle having a diameter of 300 μm or more” in the present specification indicates a particle which remains on a JIS standard sieve, whose opening is 300 μm, after classification by a sieve classification method (will be described later). Moreover, “a particle having a diameter of smaller than 300 μm” indicates a particle which has passed through a mesh, whose opening is 300 μm, after classification by the classification method (will be described later). The same is true for other size openings. Moreover, when 50% by mass of particles are classified by a mesh whose opening is 300 μm, the mass average particle diameter (D50) is 300 μm.

The particle shape of the water-absorbing resin particle is not limited to a spherical shape, a crushed shape, an irregular shape, etc. However, preferably used is the water-absorbing resin particle having an irregular crushed shape obtained through a crushing step.

Note that a particle size adjustment of the water-absorbing resin particle can be carried out accordingly by the polymerization, hydrate polymer crushing (hydrate polymer fragmentation), the drying, the crushing, the classification, the granulation, a mixing of plural kinds of water-absorbing resin particles, etc.

Surface-Cross-Linking Water-Absorbing Resin Particle

The surface-cross-linking water-absorbing resin particle can be used as the water-absorbing resin particle. The surface-cross-linking water-absorbing resin particle is the water-absorbing resin particle which has been subjected to a surface cross-linking (secondary cross-linking).

There are various cross-linking agents for carrying out the surface cross-linking. However, in view of the physical property, generally used are a polyalcohol compound, an epoxy compound, a polyamine compound, a condensate of a polyamine compound and an haloepoxy compound, an oxazoline compound, a monooxazolidinone compound, a dioxazolidinone compound, a polyoxazolidinone compound, a polymetal salt, an alkylene carbonate compound, etc.

Specific examples of the surface cross-linking agent are surface cross-linking agents disclosed in U.S. Pat. Nos. 6,228,930, 6,071,976, 6,254,990, etc. The examples are: a polyalcohol compound, such as monoethylene glycol, diethylene glycol, triethylene glycol, tetraethylene glycol, polyethylene glycol, 1,2-propylene glycol, 1,3-propanediol, dipropylene glycol, 2,3,4-trimethyl-1,3-pentanediol, polypropylene glycol, glycerin, polyglycerin, 2-butene-1,4-diol, 1,4-butanediol, 1,3-butanediol, 1,5-pentanediol, 1,6-hexanediol, and 1,2-cyclohexanedimethanol; an epoxy compound, such as ethylene glycol diglycidyl ether and glycidol; a polyamine compound, such as ethylenediamine, diethylenetriamine, triethylenetetramine, tetraethylenepentamine, pentaethylenehexamine, polyethyleneimine, and polyamidepolyamine; an haloepoxy compound, such as epichlorohydrin, epibromohydrin, and α-methylepichlorohydrin; condensate of the polyamine compound and the haloepoxy compound; an oxazolidinone compound (U.S. Pat. No. 6,559,239), such as 2-oxazolidinone; an oxetane compound; a cyclic urea compound; and an alkylene carbonate compound (U.S. Pat. No. 5,409,771), such as ethylene carbonate. Among these cross-linking agents, it is preferable to use at least one selected from at least the oxetane compound (US2002/72,471), the cyclic urea compound, and the polyalcohol. It is more preferable to use at least one selected from an oxetane compound having 2 to 10 carbons and polyalcohol having 2 to 10 carbons. It is further preferable to use polyalcohol having 3 to 8 carbons.

The amount of the surface cross-linking agent to be used depends on a compound to be used and a combination of compounds to be used. However, the amount of the surface cross-linking agent to be used is in a range preferably from 0.001 part by mass to 10 parts by mass with respect to 100 parts by mass of the water-absorbing resin, and more preferably from 0.01 part by mass to 5 parts by mass.

It is preferable to use water for the surface cross-linking. In this case, the amount of water to be used depends on the water content of the water-absorbing resin to be used. However, the amount of water to be used is in a range preferably from 0.5 part by mass to 20 parts by mass with respect to 100 parts by mass of the water-absorbing resin, and more preferably from 0.5 part by mass to 10 parts by mass. Moreover, other than water, a hydrophilic organic solvent may be used in the present invention. The hydrophilic organic solvent is in a range from preferably 0 part by mass to 10 parts by mass with respect to 100 parts by mass of the water-absorbing resin, more preferably from 0 part by mass to 5 parts by mass, and further preferably from 0 part by mass to 3 parts by mass.

Further, among various mixing methods, it is preferable to use a method for (i) mixing the surface cross-linking agent with water and/or the hydrophilic organic solvent in advance according to need, and then (ii) spraying or dropping the resulting aqueous solution to the water-absorbing resin, and more preferably spraying the resulting solution to the water-absorbing resin. The average particle diameter of the droplets to be sprayed is preferably from 1 μm to 300 μm, and more preferably from 10 μm to 200 μm. Moreover, when mixing, a water-insolube fine particle powder and/or a surfactant may coexist as long as it does not spoil the effect of the present invention.

The water-absorbing resin having been mixed with the cross-linking agent is preferably subjected to a heat treatment. When carrying out the heat treatment, a heating temperature (defined by a heat medium temperature) is preferably from 100° C. to 250° C., and more preferably from 150° C. to 250° C., and a heating time is in a range preferably from 1 minute to 2 hours. Preferred examples of a combination of the temperature and time are a combination of 180° C. and 0.1 hour to 1.5 hours and a combination of 200° C. and 0.1 hour to 1 hour.

Characteristic of Water-Absorbing Resin Particle

The characteristic of the water-absorbing resin particle affects the characteristic of the resulting water-absorbing resin composition. Therefore, it is desirable that the water-absorbing resin particle be excellent in performances that the water-absorbing resin composition needs. For example, it is desirable that the water-absorbing resin particle have the following characteristics.

Water Content

In view of the physical property of the resulting water-absorbing resin composition, it is desirable that the water-absorbing resin particle be powder which is flowable even at room temperature.

Therefore, the water content (defined by the amount of water contained in the water-absorbing resin particle, and measured by (i) evenly spreading 1 gram of particles in an aluminum cup having a diameter of 5 cm, (ii) drying the particles at 105° C. for 3 hours, and then (iii) measuring the decreased amount of water) of the water-absorbing resin particle is preferably 0.1% by mass to 40% by mass, more preferably 0.2% by mass to 30% by mass, further preferably 0.3% by mass to 15% by mass, and especially preferably 0.5% by mass to 10% by mass, and the water-absorbing resin particle is a powder. When the water content of the water-absorbing resin particle is higher than 40% by mass, the water absorption ratio may decrease. When the water content is lower than 0.1% by mass, the liquid suction property may decrease.

Soluble Element

The smaller the amount of the soluble element of the water-absorbing resin particle is, the better. Specifically, the amount of the soluble element is set to 25% by mass or smaller (the lower limit is 0% by mass). The amount of the soluble element is more preferably 20% by mass or smaller, and further preferably 15% by mass or smaller.

Centrifuge Retention Capacity (CRC)

The higher the CRC value of the water-absorbing resin particle is, the higher the CRC value of the resulting water-absorbing resin composition becomes. Normally, the CRC value of the water-absorbing resin composition is lower than that of the water-absorbing resin particle. Here, it is possible to set the CRC value of the water-absorbing resin particle to 20 g/g to 50 g/g, preferably 20 g/g to 45 g/g, more preferably 20 g/g to 40 g/g, and most preferably 20 g/g to 35 g/g.

Absorbency Against Pressure (AAP)

Also, the AAP value of the water-absorbing resin composition tends to be lower than that of the water-absorbing resin particle. Here, it is possible to set the AAP value of the water-absorbing resin particle to 10 g/g to 35 g/g, preferably 15 g/g to 35 g/g, and more preferably 18 g/g to 30 g/g.

Saline Flow Conductivity (SFC)

The SFC value of the water-absorbing resin composition is normally higher than that of the water-absorbing resin particle. However, if the SFC value of the water-absorbing resin particle is high, the SFC value of the water-absorbing resin composition tends to become high. Here, it is possible to set the SFC value of the water-absorbing resin particle to 1×10⁻⁷·cm³·s·g⁻¹ to 1500×10⁻⁷·cm³·s·g⁻¹, preferably 10×10⁻⁷·cm³·s·g⁻¹ to 500×10⁻⁷·cm³·s·g^{-1.}

Liquid Distribution Velocity (LDV)

The LDV value of the water-absorbing resin composition is much higher than that of the water-absorbing resin particle. Therefore, the LDV value of the water-absorbing resin particle may be comparatively low. However, the higher the LDV value of the water-absorbing resin particle is, the higher the LDV value of the water-absorbing resin composition may become. Here, it is possible to set the LDV value of the water-absorbing resin particle to 0.1 mm/s or more, and preferably 0.5 mm/s or more.

Inorganic Fine Particle

The inorganic fine particle improves the LDV, etc. of the water-absorbing resin composition.

Basically, an inorganic material used for common chemical products, medicinal products, etc. can be used as the inorganic fine particle. Used for the sanitary goods such as the paper diaper is the inorganic material having no problem with safety regarding health. It is desirable to use the inorganic material which easily expresses a target function(s) but does not cause problems such as transformation and deterioration by the manufacture processing of the water-absorbing resin composition, especially the ultraviolet rays irradiation treatment.

Specific examples of the inorganic fine particle are a photocatalytic inorganic material containing titanium oxide, and common inorganic oxides. The photocatalytic inorganic material is a material which expresses a chemical or physical photocatalytic function(s) by rays irradiation, mainly the ultraviolet rays irradiation. In the present invention, a physical or chemical change, caused by the ultraviolet rays irradiation, of state on the surface of the particle of the photocatalytic inorganic material causes the function(s) of the photocatalytic inorganic material to be expressed (for example, the LDV is improved). Other than the photocatalytic inorganic material, it is possible to use, as the inorganic fine particle, various inorganic oxides each of which improves the LDV by a change of the chemical bond on the surface of the particle, the change being caused by the irradiation of a considerable energy such as the ultraviolet rays. Specifically, examples of the inorganic fine particle are common inorganic oxides, such as silica. Moreover, these inorganic fine particles may be used alone or in combination of two or more kinds.

The inorganic fine particle may be in any shape, for example, a spherical shape, an ellipsoidal shape, a polyhedral shape, a flake shape, a fibriform shape, and an irregular shape.

The average particle diameter of the inorganic fine particles can be measured by a direct observation with a transmission electron microscope, or by a particle size distribution measuring device utilizing scattering rays. Various measurement methods may be selected depending on the size of the particle. Normally used is a method commonly used when measuring a corresponding particle diameter. Examples are a method for measuring the particle diameter by the direct observation with the transmission electron microscope, a dynamic rays scattering method, and a method in which an appropriate dispersing medium is selected and a laser diffraction/scattering particle size distribution measuring device is used. Note that a value measured with the laser diffraction/scattering particle size distribution measuring device is commonly expressed as a volume average particle diameter.

It is preferable that the average particle diameter of the inorganic fine particles be from 1 nm to 100 μm. The average particle diameter of the inorganic fine particles is more preferably from 1 nm to 50 μm, further preferably from 1 nm to 1 μm, and most preferably from 1 nm to 100 nm. If the particle diameter of the inorganic fine particle is too big or too small, an adequate improvement of the liquid diffusibility may not be obtained.

The surface of the inorganic fine particle changes physically or chemically by the ultraviolet rays irradiation treatment, and as a result, the LDV of the water-absorbing resin composition is improved. A publicly known or commercially available inorganic fine particle can be used as long as it is effective for improving the LDV of the water-absorbing resin composition.

A water-absorbing function of the water-absorbing resin composition is basically performed by the water-absorbing resin particle. Therefore, the inorganic fine particle is not required to have the water-absorbing property. If the inorganic fine particle has the water-absorbing property, the liquid diffusibility, etc. may be spoiled. It is desirable that the inorganic fine particle have the water insolubility so that it does not dissolve or transform by absorbing water.

Specific examples of the inorganic fine particle are: minerals, such as talc, kaolin, fuller's earth, bentonite, activated clay, barite, natural asphaltum, strontium ore, ilmenite, and pearlite; aluminum compounds, such as aluminum sulfate 14 to 18 hydrates (or anhydrides), aluminum potassium sulfate 12 hydrate, aluminum sodium sulfate 12 hydrate, aluminum ammonium sulfate 12 hydrate, aluminum chloride, polyaluminum chloride, and aluminum oxide; other metal salts, metal oxides and metal hydroxides; hydrophilic amorphous silicas (for example, Dry Method: Reolosil QS-20 produced by Tokuyama Corporation, Precipitation Method: Sipernat 22S, Sipernat 2200 produced by Degussa Corporation); oxide complexes, such as a complex of silicon oxide, aluminum oxide and magnesium oxide (for example, Attagel #50 produced by Engelhard Corporation), a complex of silicon oxide and aluminum oxide, and a complex of silicon oxide and magnesium oxide; etc. Moreover, the inorganic fine particles disclosed in U.S. Pat. No. 5,164,459, European Patent No. 761,241, etc. can be used. These inorganic fine particles may be used alone or in combination of two or more kinds.

Especially, preferable examples are: inorganic metal oxides, such as silica, titanium oxide, tin oxide, niobium oxide, strontium titanate, zirconium oxide, iron oxide, and tungsten oxide; silicic acids (salts), such as natural zeolite and synthetic zeolite; kaolin; talc; clay; and bentonite. These may be used alone or in combination of two or more kinds. Two or more kinds of the inorganic fine particles may be two or more kinds of the inorganic metal oxides. Specifically, two or more kinds of the inorganic metal oxides may be, for example, (i) different kinds of inorganic metal oxides (for example, a combination of different kinds of inorganic metal oxides, such as a combination of silica and titanium oxide), (ii) a compound containing two or more different kinds of inorganic metals (for example, alumina silicate that is a compound containing aluminum atom and silicon atom), and (iii) oxide of same kind of metals (including a case where the valences of metals are different). When the inorganic fine particle is two or more kinds of inorganic metal oxides, it is preferable to contain silica and titanium oxide.

Generally, the inorganic metal oxide is an oxidant of a metal element, and an oxide of a typical metal element and an oxide of a transition metal element are known. Titanium oxide, silica, etc. are transition metal oxides. Regarding titanium oxide, there are three kinds of crystal systems that are an anatase type, a rutile type, and a brookite type. The crystal system of titanium oxide is not especially limited, however the anatase type is the most preferable since it shows photocatalysis the most.

Silica is a general term for silicon dioxides, and includes synthetic amorphous silicon dioxide, natural amorphous silicon dioxide, and crystalline silicon dioxide. “AEROSIL 200” (produced by Nippon Aerosil Co., Ltd.) is included in synthetic amorphous silica.

Moreover, these inorganic fine particles may exist as dispersion colloid state in water, a hydrophilic organic solvent, or a mixture of water and a hydrophilic organic solvent. Examples of the dispersion colloid of the inorganic fine particle are “Aldrich Ludox HS-30” (produced by Du Pont), “Aldrich Ludox CL” (produced by Du Pont), “STS-21” (produced by Ishihara Sangyo Co., Ltd.), etc.

When the inorganic fine particle B is a mixture of two or more kinds of inorganic fine particles, its blend ratio can be changed arbitrarily. For example, when the inorganic fine particle B is a mixture of two kinds of inorganic fine particles that are silica and titanium oxide, an appropriate addition amount (mixture mass ratio) can be determined depending on miscibility or the physical property of the desired water-absorbing resin composition. The mixture mass ratio is, for example, in a range preferably from 1 (silica): 99 (titanium oxide) to 99 (silica):1 (titanium oxide), more preferably from 10:90 to 90:10, especially preferably from 20:80 to 80:20, and most preferably from 30:70 to 70:30.

As described above, when mixing two or more kinds of inorganic fine particles, a desired character(s) can be expressed by a combination of specific characteristics (the particle shape, the particle size, an aggregability, a bulk specific gravity) of respective inorganic oxides. Specifically, each kind of inorganic fine particle has various strong points and weak points. Therefore, by combining two or more kinds of inorganic fine particles at an arbitrary blend ratio so that these two or more kinds of the inorganic fine particles cover respective strong points and weak points each other, the respective strong points can be maintained, while the respective weak points can be reduced. For example, in the case of using a mixture containing two or more kinds of inorganic oxides including silica having the aggregability and titanium oxide having an effect of suppressing aggregation, the miscibility of the water-absorbing resin improves, and the LDV value, that is the target physical property, can be maintained, as compared with the case of using silica alone and the case of using titanium oxide alone.

Other Components

In addition to the water-absorbing resin A and the inorganic fine particle B, the other particle component and/or liquid component can be added to the water-absorbing resin composition, as far as the addition of the other particle component and/or liquid component does not spoil the object of the present invention.

Examples of added component are: deodorants, antibacterial agents, aroma chemicals, foaming agents, pigments, dyes, plasticizers, adhesives, surfactants, fertilizers, oxidizing agents, reducers, water, salts, chelating agents, disinfectants, hydrophilic polymers such as polyethylene glycol, paraffins, hydrophobic polymers, thermoplastic resins such as polyethylene and polypropylene, thermosetting resins such as polyester resin and urea resin, etc.

Other than the inorganic fine particle B which has been subjected to the ultraviolet rays irradiation treatment, it is possible to add an inorganic fine particle which is the same material as the inorganic fine particle B but not subjected to the ultraviolet rays irradiation treatment.

The addition amount of a component(s) other than the water-absorbing resin A and the inorganic fine particle B can be set to a range from 0% by mass to 15% by mass with respect to the total amount of the water-absorbing resin A and the inorganic fine particle B.

Mixing of Water-Absorbing Resin Particle and Inorganic Fine Particle

If it is possible to carry out a homogeneous mixing, commonly used means for mixing particle materials is applicable to a mixing of the water-absorbing resin A, the inorganic fine particle B, and the other component(s). Normally, a dry blending method of directly mixing particles is used. However, a wet blending method using the inorganic fine particle as slurry or colloid is used in some cases.

Specific examples of a mixing apparatus are normal mixing devices, such as a V type mixing device, a ribbon type mixing device, a screw type mixing device, a rotating-disc type mixing device, an airflow type mixing device, a batch kneader, a continuous kneader, and a paddle type mixing device.

Manufacture of Water-Absorbing Resin Composition

Basically, a common water-absorbing resin manufacturing technique may be used to manufacture the water-absorbing resin composition containing the water-absorbing resin A and the inorganic fine particle B which has been irradiated with the ultraviolet rays.

It is preferable that the water-absorbing resin A and the inorganic fine particle B be mixed uniformly. It is possible to use a mixing method and mixing apparatus which are used when manufacturing a common water-absorbing resin or when mixing particulates.

In the water-absorbing resin composition, the water-absorbing resin A and the inorganic fine particle B are contained by a ratio (weight ratio) of 100:0.01 to 100:10, preferably 100:0.01 to 100:8, more preferably 100:0.01 to 100:5, especially preferably 100:0.01 to 100:3, and most preferably 100:0.01 to 100:1. The mixing is preferably carried out with respect to the surface of the water-absorbing resin, so as to obtain the water-absorbing resin composition whose surface is coated with the inorganic fine particles. If a certain amount or more of the inorganic fine particle B does not exist with respect to the water-absorbing resin A, it is impossible to achieve effects, such as the improvement of the liquid diffusibility. If the amount of the water-absorbing resin A is too small, the proper water-absorbing performance is not shown adequately.

Note that the total amount of the water-absorbing resin A and the inorganic fine particle B is 60% by mass or more with respect to the total amount of the water-absorbing resin composition, preferably 85% by mass or more, more preferably 90% by mass or more, and further preferably 95% by mass or more.

A timing, method, and treatment condition of carrying out the ultraviolet rays treatment with respect to the inorganic fine particle B are not especially limited.

The above-described step (I) or step (II) is adopted depending on the timing of carrying out the ultraviolet rays irradiation treatment with respect to the inorganic fine particle B.

Ultraviolet Rays Irradiation Treatment

Basically, it is possible to use an ultraviolet rays irradiation treatment technology and ultraviolet rays irradiation device which are utilized in manufacturing technologies of various chemical products including a manufacturing technology of common water-absorbing resin. Examples of the ultraviolet rays irradiation device are a high-pressure mercury lamp, a low-pressure mercury lamp, a metal halide lamp, a xenon lamp, a halogen lamp, etc. As a condition of the ultraviolet rays irradiation treatment, rays contain an ultraviolet region of wavelength 200 nm to 400 nm, and may include the other wavelength(s).

Regarding the condition of the ultraviolet rays irradiation, the irradiation of the ultraviolet rays is carried out for 1 second to 60 minutes, the irradiation intensity of the ultraviolet rays is 1 mW/cm² to 1,000 mW/cm², and the irradiation dose of the ultraviolet rays is 100 mJ/cm² to 10,000 mJ/cm². The irradiation intensity of the ultraviolet rays is more preferably 1 mW/cm² to 500 mW/cm², further preferably 1 mW/cm² to 300 mW/cm², and most preferably 1 mW/cm² to 100 mW/cm². The irradiation dose of the ultraviolet rays is more preferably 100 mJ/cm² to 5,000 mJ/cm², further preferably 100 mJ/cm² to 3,000 mJ/cm², and most preferably 100 mJ/cm² to 1,000 mJ/cm². An irradiation time of the ultraviolet rays is more preferably 0.2 minute to 30 minutes, further preferably 0.5 minute to 15 minutes, and most preferably 1 minute to 10 minutes. Note that the irradiation intensity of the ultraviolet rays is defined by a method descried in the following Examples.

When the inorganic fine particle B is irradiated with the ultraviolet rays, and when the mixture of the water-absorbing resin A and the inorganic fine particle B is irradiated with the ultraviolet rays, it is preferable that an ultraviolet rays irradiated object be irradiated with the ultraviolet rays entirely and uniformly. It is more preferable that the ultraviolet rays irradiated object be stirred so as to be irradiated with the ultraviolet rays entirely and uniformly. As a device which stirs the ultraviolet rays irradiated object when the ultraviolet rays irradiated object is irradiated with the ultraviolet rays, it is possible to use a common stirring device. Examples of the stirring device are a vibration type mixing device, a ribbon type mixing device, a paddle type mixing device, etc.

Generally, the shorter the wavelength of the ultraviolet rays is, the higher the effect of the ultraviolet rays treatment with respect to the inorganic fine particle is. However, realizing the shorter wavelength costs a lot because, for example, a treatment device becomes complex. If the energy intensity is low, the target effect does not improve adequately. If the ultraviolet rays irradiation treatment is too strong or too long, the effect does not improve, and the deterioration and/or damage of the inorganic fine particle or the water-absorbing resin particle easily occur.

In the ultraviolet rays irradiation treatment, the internal temperature of the treatment device increases in some cases. For example, in the case of starting the treatment at normal temperature, the internal temperature becomes up to nearly 60° C. in some cases. Even if the mixture of the water-absorbing resin A and the inorganic fine particle B is heated to 60° C., the improvement of the LDV is hardly obtained. Therefore, the improvement of the LDV by the ultraviolet rays irradiation is not caused by the temperature increase.

Addition of Water

In a method for manufacturing the water-absorbing resin composition of the present invention, before the irradiation of the ultraviolet rays, it is possible to add water, the amount of which is 0.1% by mass to 5% by mass with respect to the total amount of the water-absorbing resin composition containing the mixture of the water-absorbing resin A and the inorganic fine particle B (the total amount of the water-absorbing resin composition before the addition of water). The amount of water to be added is preferably 0.1% by mass to 1% by mass.

By adding water, the effect of the ultraviolet rays irradiation is expressed further efficiently, and the water-absorbing performances including the LDV can be improved further.

The influence of the addition of water on the LDV varies depending on the kind of the inorganic fine particle B. This may be because the affinity of the inorganic fine particle B for water varies depending on the kind of the inorganic fine particle B. If the inorganic fine particle B is highly hydrophilic, the performance(s) of the inorganic fine particle B is highly improved by the ultraviolet rays irradiation treatment.

The improvement of the LDV can be achieved by adding water to the mixture of the water-absorbing resin A and the inorganic fine particle B which has been irradiated with the ultraviolet rays. In this case, the improvement of the LDV is not affected by the kind of the inorganic fine particle B.

Regarding the improvement of the LDV by the addition of water, it is most effective to add water to the mixture of the water-absorbing resin A and the inorganic fine particle B before the irradiation of the ultraviolet rays.

In order to improve the performances such as the LDV, it is effective to add water to the inorganic fine particle B, irradiate the inorganic fine particle B with ultraviolet rays, and mix the inorganic fine particle B with the water-absorbing resin A. In this case, it is preferable to add water, the addition amount of which is 0.1% by mass to 5% by mass with respect to the total amount of the water-absorbing resin composition (the total amount of the water-absorbing resin composition before the addition of water), and it is more preferable that the addition amount of water is 0.1% by mass to 1% by mass.

Water-Absorbing Resin Composition

Through these manufacturing steps explained above, the water-absorbing resin composition is obtained. Other than these steps, the water-absorbing resin composition can be manufactured through a combination of various manufacturing steps adopted when manufacturing a common water-absorbing resin composition.

For example, in addition to the water-absorbing resin A and the inorganic fine particle B, the water-absorbing resin composition may contain the other addition agent as the component of the water-absorbing resin composition, as far as the addition agent does not spoil the effects of the present invention.

The shape and size of the water-absorbing resin composition is basically the same as those of the water-absorbing resin. Most of the basic characteristics of the water-absorbing resin composition are also the same as those of the water-absorbing resin. However, some characteristics of the water-absorbing resin composition are noticeably different from those of the water-absorbing resin. Note that it is preferable that the water-absorbing resin composition be particulate.

Characteristics of Water-Absorbing Resin Composition

It is desirable that the water-absorbing resin composition have the following characteristics. Values of respective characteristics are measured by measurement methods which will be described later.

Liquid Distribution Velocity (LDV)=2.0 mm/s to 10 mm/s (more preferably 2.8 mm/s to 10 mm/s, further preferably 3.0 mm/s to 10 mm/s, and especially preferably 3.5 mm/s to 10 mm/s)

Centrifuge Retention Capacity (CRC)=20 g/g to 50 g/g (more preferably 20 g/g to 45 g/g, further preferably 20 g/g to 40 g/g, and most preferably 20 g/g to 35 g/g)

Absorbency Against Pressure (AAP)=10 g/g to 35 g/g (more preferably 15 g/g to 30 g/g, and further preferably 18 g/g to 30 g/g)

Saline Flow Conductivity (SFC)=1×10⁻⁷·cm³·s·g⁻¹ to 1500×10⁻⁷·cm³·s·g⁻¹ (more preferably 10×10⁻⁷·cm³·s·g⁻¹ to 500×10⁻⁷·cm³·s·g⁻¹)

The LDV is a parameter indicating “the liquid suction property”. Upon improving the performances of absorbent products such as the paper diaper and a sanitary napkin, or the performances of the absorber, the CRC relates to the amount of liquid to be absorbed by the absorbent product or the absorber whereas the LDV relates to the velocity of the liquid diffusing in the absorbent product or in the absorber, and particularly to the initial velocity of liquid being absorbed.

In the case of using the water-absorbing resin composition, whose SFC is too large, as the absorber or the absorbent product such as the paper diaper, problems such as leakage, skin rash, etc. occur.

When a load such as a body weight is applied to the water-absorbing resin composition whose AAP is too small and/or whose SFC is too small, the liquid diffusibility and absorbing ability deteriorate. The liquid does not diffuse in the absorber or absorbent product, and blocking of the liquid occurs. For example, in the case of practically using the paper diaper, problems such as the leakage, skin rash, etc. easily occurs.

If the water-absorbing resin composition has adequate basic water-absorbing performances that are the CRC, the AAP and the SFC in addition to the LDV indicating the liquid diffusibility, the water-absorbing resin composition can show a practically excellent performance in various applications.

By dramatically improving the LDV (to be higher than is attainable using a conventional water-absorbing resin composition) of the water-absorbing resin composition whose CRC is sufficiently excellent (20 g/g or more), it is possible to obtain the water-absorbing resin composition having excellent liquid diffusibility.

Further, if the LDV is 2.0 mm/s or more, it is possible to critically and significantly improve the liquid diffusibility of the water-absorbing resin composition such as a diaper used practically, as compared with the conventional technology.

In addition to the above-described LDV, SFC, CRC, and AAP, it is preferable that the water-absorbing resin composition have the following characteristics regarding the water content, the amount of the soluble element and the particle size.

The water content of the water-absorbing resin composition of the present invention is defined by the water amount of with respect to the total amount of the water-absorbing resin composition containing the water-absorbing resin A and the inorganic fine particle B (defined by the amount of water contained in the water-absorbing resin composition, and defined by the decreased amount of water decreased by the drying at 105° C. for 3 hours). In the case of adding water to the water-absorbing resin composition, the water content is defined by the water amount after the addition of water.

The water content of the water-absorbing resin composition can be set to 0.1% by mass to 40% by mass accordingly by the drying or the addition of water. The water content is more preferably 0.2% by mass to 30% by mass, further preferably 0.3% by mass to 15% by mass, and especially preferably 0.5% by mass to 10% by mass. When the water content is higher than 40% by mass, the water absorption ratio may be reduced. When the water content is lower than 0.1% by mass, the liquid suction property may be reduced.

The smaller the amount of the soluble element of the water-absorbing resin composition is, the better. Specifically, the amount of the soluble element is set to 25% by mass or less (the lower limit is 0% by mass). The amount of the soluble element is more preferably 20% by mass or less, and further preferably 15% by mass or less.

The particle size of the water-absorbing resin composition is a mixture of the particle size of the water-absorbing resin particle and the particle size of the inorganic fine particle B. By adjusting the blend ratio of the inorganic fine particle B, the particle size of the water-absorbing resin composition can be set within a preferable particle size range. Note that it is preferable that the particle size of the water-absorbing resin composition be in the above-described particle size range of the water-absorbing resin particle.

Applications of Water-Absorbing Resin Composition

The water-absorbing resin composition obtained by the present invention can be used in various applications in which the common water-absorbing resin composition is used. Especially the water-absorbing resin composition of the present invention is well-suited to an application which requires high liquid diffusibility.

Specific examples of the application are hygienic goods, such as adult paper diapers whose market have been remarkably growing in recent years, child diapers, sanitary napkins, and so-called incontinence pads. Moreover, the water-absorbing resin composition of the present invention can also be used in applications, such as agriculture, horticulture, cable water stop agents, civil engineering, architecture, and food products, in which the water-absorbing resin composition has been used conventionally.

The present invention is not limited to the description of the embodiments above, but may be altered by a skilled person within the scope of the claims. An embodiment based on a proper combination of technical means disclosed in different embodiments is encompassed in the technical scope of the present invention.

### EXAMPLES

The following will more specifically explain the present invention through Examples. However, the present invention is not limited to these. In the following description, for the sake of convenience, “part(s) by mass” may be referred to as “part(s) by weight” or “part(s)”, and “liter(s)” may be referred to as “L”. Moreover, “% by mass” may be referred to as “wt %”.

Performance Evaluation Method

Performances of the water-absorbing resin particle or the water-absorbing resin composition are measured by the following method. However, as long as a performance evaluation similar to the above can be carried out, other measuring devices and different measurement conditions usable in a technical field of the water-absorbing resin can be used here.

Unless otherwise specified, each measurement was carried out under a condition of room temperature (20° C. to 25° C.) and 50% RH.

In the case of the water-absorbing resin composition having been used as the end product such as the hygienic good, the water-absorbing resin composition is wet. Therefore, measurement is carried out after this wet water-absorbing resin composition is separated from the end product, and then is dried under reduced pressure at low temperature (for example, under pressure of 1 mmHg or less at 60° C. for 12 hours).

Centrifuge Retention Capacity (CRC)

The centrifuge retention capacity (CRC) indicates the absorption ratio measured under no pressure for 30 minutes using a 0.90% by mass saline solution.

0.200 gram of the water-absorbing resin particle or the water-absorbing resin composition was uniformly put into a bag (85 mm×60 mm) made of nonwoven fabric (produced by Nangoku Pulp Kogyo Co., Ltd., Product Name: Heatron Paper, Type: GSP-22), and the bag was heat sealed and immersed in a large excess (usually about 500 ml) of the 0.90% by mass saline solution (sodium chloride aqueous solution) at room temperature. The bag was pulled out of the solution 30 minutes later, was drained off using a centrifuge (produced by Kokusan Co., Ltd., Centrifuge: Type H-122) by centrifugal force (250G) described in “edana ABSORBENCY II 441.1-99” for 3 minutes. Then, a weight W1 (gram) of the bag was measured. Moreover, the same operation was carried out without the water-absorbing resin particle and the water-absorbing resin composition. Then, a weight W0 (gram) of the bag was measured. Then, the centrifuge retention capacity (CRC) (g/g) was calculated by the following formula using W1 and W0.

Centrifuge Retention Capacity (CRC) (g/g)=(W1 (g)−W0 (g))/(Weight (g) of Water-absorbing Resin Particle or Water-absorbing Resin Composition)−1

Absorbency Against Pressure (AAP)

The absorbency against pressure (AAP) indicates the absorption ratio measured under pressure of 4.83 kPa for 60 minutes using the 0.90% by mass saline solution. Note that the AAP may also be referred to as “an absorption ratio under pressure of 4.83 kPa”.

A stainless steel 400 mesh metal screen (mesh size 38 μm) was fused to the bottom of a plastic supporting cylinder whose internal diameter is 60 mm, and 0.900 gram of the water-absorbing resin particle or the water-absorbing resin composition was sprinkled on the metal screen under a condition of room temperature (20° C. to 25° C.) and 50% RH. Then, a piston and a spindle were provided in this order on the water-absorbing resin particle or the water-absorbing resin composition. The piston and the spindle were adjusted so as to apply load of 4.83 kPa (0.7 psi) uniformly to the water-absorbing resin particle or the water-absorbing resin composition. Each of the piston and the spindle has an external diameter which is slightly smaller than 60 mm so that (i) there is no gap between the piston (spindle) and the supporting cylinder and (ii) the vertical motions of the piston (spindle) were smooth. A weight Wa (gram) of this complete set of measuring device was measured.

A glass filter (produced by Sogo Laboratory Glass Works Co., Ltd., Pore Diameter: 100 μm to 120 μm) whose diameter is 90 mm was placed inside a petri dish whose diameter is 150 mm, the 0.90% by mass saline solution (20° C. to 25° C.) was added to the petri dish so that the liquid level of the 0.90% by mass saline solution is the same as the top surface of the glass filter. Then, a piece of filter paper (Advantec Toyo Co., Ltd., Product name “2”, Thickness 0.26 mm, Retaining particle diameter 5 μm) whose diameter is 90 mm is placed on the glass filter so that the surface of the filter paper got wet entirely, and excessive liquid was removed.

The complete set of measuring device was placed on the wet filter paper, and the liquid was absorbed under pressure. The complete set of measuring device was lifted up an hour later, and a weight Wb (gram) of the measuring device was measured. Then, the absorbency against pressure (AAP) (g/g) was calculated by the following formula using Wa and Wb.

Absorbency Against Pressure (AAP)=(Wb (g)−Wa (g))/(Weight (0.900 gram) of Water-absorbing Resin Particle or Water-absorbing Resin Composition)

Saline Flow Conductivity (SFC)

The saline flow conductivity (SFC) indicates the value of the liquid permeability when the water-absorbing resin particle or the water-absorbing resin composition is swollen. The larger the SFC value, the higher the liquid permeability is. The measurement was carried out in accordance with a saline flow conductivity (SFC) test disclosed in a published Japanese translation of PCT international publication for patent application No. 9-509591 (Tokuhyohei 9-509591).

The water-absorbing resin particle or the water-absorbing resin composition (0.900 gram) uniformly put into a container swelled in artificial urine (1) under pressure of 0.3 psi (2.07 kPa) for 60 minutes, and then the height of a gel layer of a gel was recorded. Next, under pressure of 0.3 psi (2.07 kPa), a 0.69% by mass saline solution was supplied from a tank at a certain hydrostatic pressure so as to pass through the swollen gel layer. This SFC test was carried out at room temperature (20° C. to 25° C.). Using a computer and a balance, the amount of liquid passing through the gel layer was recorded every 20 seconds for 10 minutes as a function of time. A flow speed Fs (T) of the liquid passing through (mainly between the particles of) the swollen gel was determined by dividing an increased weight (gram) by an increased time (s) and expressed by g/s. A time the hydrostatic pressure became constant and the flow speed became stable is Ts. Data obtained in 10 minutes from Ts is used for calculating the flow speed. Then, the value of Fs (T=0), that is, an initial flow speed of the liquid passing through the gel layer was calculated using the flow speed. Fs (T=0) was extrapolated from a result of a least square method of Fs(T) versus time.

$$Saline Flow Conductivity ( SFC ) \\ = ( Fs ( t = 0 ) \times L 0 ) / ( ρ \times A \times Δ P ) \\ = ( Fs ( t = 0 ) \times L 0 ) / 139506$$

In this formula, Fs (t=0) denotes the flow speed and is shown by g/s, L0 denotes the height of the gel layer and is shown by cm, ρ denotes the density of a NaCl solution (1.003 g/cm³), A denotes the area of an upper surface of the gel layer in a cell 41 (28.27 cm²), and ΔP denotes the hydrostatic pressure applied to the gel layer (4,920 dyne/cm²). In addition, the unit of the SFC value is 10⁻⁷·cm³·s·g⁻¹.

Regarding the measuring device, a glass tube is inserted into the tank, the lower end of the glass tube is placed so that the liquid level of the 0.69% by mass saline solution is maintained to be 5 cm above the bottom of the swollen gel in the cell. The 0.69% by mass saline solution in the tank is supplied to the cell through an L-shaped tube having a cock. A container for collecting the liquid having passed through the cell is placed under the cell, and this collecting container is placed on an even balance. The internal diameter of the cell is 6 cm, and a No. 400 stainless steel metal screen (mesh size 38 μm) is provided at the bottom of the cell. A hole allowing liquid to pass through is formed at a lower portion of the piston, and a glass filter having good permeability is provided at a bottom so that the water-absorbing resin particle, the water-absorbing resin composition, and the swollen gel does not get into the hole. The cell is placed on a base for mounting the cell, and a stainless steel metal screen which does not disturb the penetration of the liquid is placed on a surface of the base, the surface being in contact with the cell.

Artificial urine (1) is a mixture of 0.25 gram of calcium chloride dihydrate, 2.0 grams of potassium chloride, 0.50 gram of magnesium chloride hexahydrate, 2.0 grams of sodium sulfate, 0.85 gram of ammonium dihydrogen phosphate, 0.15 gram of diammonium hydrogenphosphate, and 994.25 grams of purified water.

Mass Average Particle Diameter or Weight Average Particle Diameter (D50)

The water-absorbing resin particle or the water-absorbing resin composition was sieved by a JIS standard sieve whose mesh size is 850 μm, 710 μm, 600 μm, 500 μm, 425 μm, 300 μm, 212 μm, 150 μm, 45 μm, or the like, and a residual percentage R was plotted to a logarithmic probability sheet. Thus, the particle diameter corresponding to R=50% by mass was considered as the weight average particle diameter (D50). Note that the sieve may be changed depending on the particle diameter according to need.

The classification method used when measuring the weight average particle diameter (D50) was carried out as follows. 10.0 grams of the water-absorbing resin particle or the water-absorbing resin composition was put into the JIS standard sieve (THE IIDA TESTING SIEVE: Diameter of 8 cm) having the above-described mesh size under a condition of room temperature (20° C. to 25° C.) and 50% RH, and classified with a sieve shaker (IIDA SIEVE SHAKER, TYPE: ES-65, SER. No. 0501) for five minutes.

Liquid Distribution Velocity (LDV)

The liquid distribution velocity (LDV) was measured by using a suction index (wicking index) measuring device disclosed in Japanese Unexamined Patent Application No. 200068/1993 (Tokukaihei 5-200068 (EP532002)). Note that a trough sheet is made by SUS304 stainless steel (grade 2B finishing).

1.00 gram (±0.005 gram) of the particulate water-absorbing resin composition was sprinkled uniformly between a scale marking 0 cm to a scale marking 20 cm of each of trough grooves of the trough sheet provided at an angle of 20°. Further, the particulate water-absorbing resin composition was sprinkled further uniformly with a spatula.

The liquid used for liquid suction was a colored normal saline solution obtained by mixing 1 L of normal saline solution (0.90% by mass sodium chloride aqueous solution) with 0.01 gram of food blue No. 1 (Tokyo Chemical Industry Co., Ltd.).

The liquid level in a liquid storage tank was adjusted so as to be 0.5 cm above the lowest position of the trough. The measurement of a liquid suction time (WR) was started at the moment a stainless steel screen mesh contacted the liquid. The measurement of the liquid suction time (WR) (sec) ended at the moment the liquid reached a scale marking 10 cm. Note that the speed of the liquid diffusing from the lowest position of the trough to a position 0.5 cm above the lowest position of the trough was 1.35 mm/s to 1.40 mm/s in a vertical direction from the liquid level.

The liquid distribution velocity (LDV) is calculated by the following formula.

LDV (mm/s)=100 (mm)/WR (s)

Amount of Soluble Element

184.3 grams of the 0.900% by mass sodium chloride aqueous solution was measured and poured in a lidded plastic container (diameter 6 cm×height 9 cm) whose capacity was 250 ml, 1.00 gram of the (particulate) water-absorbing resin (composition) was added to this aqueous solution, and this mixture was stirred with a magnetic stirrer (diameter 8 mm, length 25 mm) at 500 rpm for 16 hours. Thus, the soluble element in the (particulate) water-absorbing resin (composition) was extracted. This extracted liquid was filtered by a piece of filter paper (Advantec Toyo Co., Ltd., Product Name “2”, Thickness 0.26 mm, Retaining Particle Diameter 5 μm), and 50.0 grams of the obtained filtrate was measured as a measurement solution.

First, only the 0.90% by mass sodium chloride aqueous solution was titrated with 0.1N NaOH aqueous solution to pH10, and then was titrated with 0.1N HCl aqueous solution to pH2.7. Thus, blank titer ([bNaOH] ml, [bHCl] ml) was obtained. Similar titration was carried out with respect to the measurement solution. Thus, titer ([NaOH] ml, [HCl] ml) was obtained.

For example, in the case of the water-absorbing resin containing known amounts of acrylic acid and its sodium salt, the amount of the soluble element in the water-absorbing resin can be calculated by the following formula using the average molecular weight of the monomer and the titer obtained by the above-described titration.

Amount of Soluble Element (% by mass)=0.1×(Average Molecular Weight)×184.3×100×([HCl]−[bHCl])/1,000/1.0/50.0

Note that when the amount of acrylic acid was unknown, the average molecular weight of the monomer was calculated using a neutralization rate obtained by the titration.

Neutralization Rate (mole %)=[1−([NaOH]−[bNaOH])/([HCl]−[bHCl])]×100

Manufacture of Water-Absorbing Resin Composition

### Manufacture Example 1

505.6 grams of acrylic acid, 4,430.8 grams of 37% by mass acrylic acid sodium aqueous solution, 497.0 grams of purified water, and 12.79 grams of polyethylene glycol diacrylate (molecular weight 523) were dissolved in a reactor made by lidding a jacketed stainless twin-arm kneader having two sigma blades and 10 liters in capacity. Thus, reaction liquid was prepared. Next, this reaction liquid was degassed for 20 minutes with nitrogen gas. Then, 29.34 g of the 10% by mass sodium persulfate aqueous solution and 24.45 grams of the 0.1% by mass L-ascorbic acid aqueous solution were added to the reaction liquid while stirring. About one minute later, polymerization started. Then, the polymerization was carried out at 20° C. to 95° C. while the generated gel was being crushed. A hydrated gel cross-linked polymer was taken out 30 minutes after the polymerization started. The obtained hydrated gel cross-linked polymer was fragmented so that the diameter of each fragmented piece was about 5 mm or less.

These fragmented pieces of the hydrated gel cross-linked polymer were sprinkled on a 50 mesh metal screen, and were dried by hot air of 180° C. for 50 minutes. The dried pieces were crushed with a roll mill, and the crushed pieces were further classified by JIS standard sieves whose mesh size were 600 μm and 150 μm. Thus, obtained were irregular crushed shape water-absorbing resin particles (1) whose weight average particle diameter was 350 μm. The centrifuge retention capacity (CRC) of the water-absorbing resin particle (1) was 33.0 g/g, and the soluble element of the water-absorbing resin particle (1) was 9.0% by mass.

100 parts by mass of the obtained water-absorbing resin particle(s) (1) was uniformly mixed with a surface preparation agent that was a liquid mixture of 0.32 part by mass of 1,4-butanediol, 0.5 part by mass of propylene glycol, and 2.73 parts by mass of purified water. Then, the resulting mixture was subjected to a heat treatment of 200° C. for 30 minutes. Further, the particle(s) was crushed so that the crushed particle can pass through the JIS standard sieve whose mesh size was 600 μm. Thus, obtained was a water-absorbing resin particle (A1) whose surface was cross-linked.

### Manufacture Example 2

In a reactor made by lidding a jacketed stainless twin-arm kneader having two sigma blades and 10 liters in capacity, 11.7 grams (0.10 mole %) of polyethylene glycol diacrylate (the number of ethylene glycol repeating units: 9) was dissolved in 5,438 grams of acrylic acid sodium aqueous solution (the monomer concentration 39% by mass) having the neutralization rate of 71.3 mole %. Thus, reaction liquid was prepared. Next, dissolved oxygen was removed from this reaction liquid with nitrogen gas for 30 minutes. Then, 29.34 grams of 10% by mass sodium persulfate aqueous solution and 24.45 grams of 0.1% by mass L-ascorbic acid aqueous solution were added to the reaction liquid while stirring. About one minute later, polymerization started. Then, the polymerization was carried out at 20° C. to 95° C. while the generated gel was being crushed. A hydrated gel cross-linked polymer was taken out 30 minutes after the polymerization started. The obtained hydrated gel cross-linked polymer was fragmented so that the diameter of each fragmented piece was about 1 mm to 3 mm. These fragmented pieces of the hydrated gel cross-linked polymer were sprinkled on a 50 mesh metal screen (mesh size 300 em), and were dried by hot air of 175° C. for 50 minutes. Thus, obtained was a water-absorbing resin mass that was an irregular shape, can be crushed easily, and was an aggregate of particulate dry substances.

The obtained water-absorbing resin mass was crushed with a roll mill, and the crushed particles were classified by the JIS standard sieve whose mesh size was 600 μm. Next, the particles having passed through 600 μm were further classified by the JIS standard sieve whose mesh size was 150 μm. Then, the water-absorbing resin particles having passed through the JIS standard sieve whose mesh size was 150 μm were removed. Thus, the water-absorbing resin particle (2) was obtained. The amount of the soluble element in the water-absorbing resin particle (2) was 7% by mass.

100 parts by mass of the obtained water-absorbing resin particle(s) (2) was uniformly mixed with a surface preparation agent that was a liquid mixture of 0.3 part by mass of 1,4-butanediol, 0.5 part by mass of D-sorbitol, and 2.5 parts by mass of purified water. Then, the resulting mixture was subjected to the heat treatment of 205° C. for 25 minutes. Further, the particle(s) was crushed so that the crushed particle can pass through the JIS standard sieve whose mesh size was 600 μm. Thus, obtained was a water-absorbing resin particle (A2) whose surface was cross-linked.

### Example 1

100 parts by mass of the water-absorbing resin particle (A1) obtained in Manufacture Example 1 and 1 part by mass of photocatalytic titanium oxide (ST-01 produced by Ishihara Sangyo Co., Ltd.) were stirred in a stainless steel container. Then, 1 part by mass of water was further added, stirred, and mixed adequately.

This mixture was put into a quartz separable flask having a stainless steel stirring blade. While stirring the mixture at 400 rpm, the mixture was irradiated with ultraviolet rays (ultraviolet rays which contain the wavelength 200 nm to 400 nm and whose irradiation intensity measured with an ultraviolet rays integrating actinometer (produced by Ushio Inc., UIT250, Photoreceiver UVD-S254) was 65 kW/cm²) for five minutes from a position 9 cm distant from an exterior wall of the quartz separable flask.

After this irradiation, the mixture was crushed, and then caused to pass through the JIS standard sieve whose mesh size was 600 μm. Thus, a water-absorbing resin composition (E1) was obtained.

### Example 2

A water-absorbing resin composition (E2) was obtained in the same manner as described in Example 1 except that the water was not added.

### Example 3

In the stainless steel container, 1 part by mass of water was added to the water-absorbing resin composition (E2) obtained in Example 2, and this mixture was stirred and mixed adequately. Then, the obtained mixture was crushed, and then caused to pass through the JIS standard sieve whose mesh size was 600 μm. Thus, a water-absorbing resin composition (E3) was obtained.

### Example 4

A water-absorbing resin composition (E4) was obtained in the same manner as described in Example 1 except that (i) 2.5 parts by mass of photocatalytic titanium oxide (STS-21 produced by Ishihara Sangyo Co., Ltd.) slurry solution (solid content 40%) was used instead of photocatalytic titanium oxide (ST-01 produced by Ishihara Sangyo Co., Ltd.) and (ii) the water was not added.

### Example 5

A water-absorbing resin composition (E5) was obtained in the same manner as described in Example 1 except that 0.3 part by mass of silica (AEROSIL200 produced by Nippon Aerosil Co., Ltd.) was used instead of photocatalytic titanium oxide (ST-01 produced by Ishihara Sangyo Co., Ltd.).

### Example 6

A water-absorbing resin composition (E6) was obtained in the same manner as described in Example 5 except that 1 part by mass of silica (AEROSIL200 produced by Nippon Aerosil Co., Ltd.) was used instead of 0.3 parts by mass of the same.

### Example 7

A water-absorbing resin composition (E7) was obtained in the same manner as described in Example 6 except that the water was not added.

### Example 8

In the stainless steel container, 1 part by mass of water was added to the water-absorbing resin composition (E7) obtained in Example 7, and this mixture was stirred and mixed adequately. Then, the obtained mixture was crushed, and then caused to pass through the JIS standard sieve whose mesh size was 600 μm. Thus, a water-absorbing resin composition (E8) was obtained.

### Example 9

Photocatalytic titanium oxide (ST-01 produced by Ishihara Sangyo Co., Ltd.) was put into the quartz separable flask having the stainless steel stirring blade. While stirring this at 400 rpm, this was irradiated with ultraviolet rays (ultraviolet rays which contain the wavelength 200 nm to 400 nm and whose irradiation intensity measured with the ultraviolet rays integrating actinometer (produced by Ushio Inc., UIT250, Photoreceiver UVD-S254) was 65 kW/cm²) for five minutes from a position 9 cm distant from the exterior wall of the quartz separable flask. Thus, ultraviolet rays treated photocatalytic titanium oxide was obtained. 1 part by mass of the ultraviolet rays treated photocatalytic titanium oxide was mixed with 100 parts by mass of the water-absorbing resin particle (A1) obtained in Manufacture Example 1. Thus, a water-absorbing resin composition (E9) was obtained.

### Example 10

A water-absorbing resin composition (E10) was obtained in the same manner as described in Example 9 except that 0.3 part by mass of silica (AEROSIL200 produced by Nippon Aerosil Co., Ltd.) was used instead of photocatalytic titanium oxide (ST-01 produced by Ishihara Sangyo Co., Ltd.).

### Example 11

A water-absorbing resin composition (E11) was obtained in the same manner as described in Example 10 except that 1 part by mass of silica (AEROSIL200 produced by Nippon Aerosil Co., Ltd.) was used instead of 0.3 part by mass of the same.

### Example 12

1 part by mass of water was added to the water-absorbing resin composition (E9) obtained in Example 9, and this mixture was stirred and mixed adequately. Then, the obtained mixture was crushed, and then caused to pass through the JIS standard sieve whose mesh size was 600 μm. Thus, a water-absorbing resin composition (E12) was obtained.

### Example 13

1 part by mass of water was added to the water-absorbing resin composition (E10) obtained in Example 10, and this mixture was stirred and mixed adequately. Then, the obtained mixture was crushed, and then caused to pass through the JIS standard sieve whose mesh size was 600 μm. Thus, a water-absorbing resin composition (E13) was obtained.

### Example 14

1 part by mass of water was added to the water-absorbing resin composition (E11) obtained in Example 11, and this mixture was stirred and mixed adequately. Then, the obtained mixture was crushed, and then caused to pass through the JIS standard sieve whose mesh size was 600 μm. Thus, a water-absorbing resin composition (E14) was obtained.

### Example 15

A water-absorbing resin composition (E15) was obtained in the same manner as described in Example 2 except that 0.5 part by mass of photocatalytic titanium oxide (ST-01 produced by Ishihara Sangyo Co., Ltd.) and 0.5 part by mass of silica (AEROSIL200 produced by Nippon Aerosil Co., Ltd.) were used instead of 1 part by mass of photocatalytic titanium oxide (ST-01 produced by Ishihara Sangyo Co., Ltd.).

### Example 16

A mixture of photocatalytic titanium oxide (ST-01 produced by Ishihara Sangyo Co., Ltd.) and silica (AEROSIL200 produced by Nippon Aerosil Co., Ltd.) in 1:1 mass ratio was put into the quartz separable flask having the stainless steel stirring blade. While stirring the mixture at 400 rpm, the mixture was irradiated with ultraviolet rays (ultraviolet rays which contain the wavelength 200 nm to 400 nm and whose irradiation intensity measured with the ultraviolet rays integrating actinometer (produced by Ushio Inc., UIT250, Photoreceiver UVD-S254) was 65 kW/cm²) for five minutes from a position 9 cm distant from the exterior wall of the quartz separable flask. Thus, an ultraviolet rays treated mixture was obtained. 1 part by mass of the ultraviolet rays treated mixture was mixed with 100 parts by mass of the water-absorbing resin particle (A1) obtained in Manufacture Example 1. Thus, a water-absorbing resin composition (E16) was obtained.

### Example 17

A water-absorbing resin composition (E17) was obtained in the same manner as described in Example 2 except that 0.3 part by mass of photocatalytic titanium oxide (ST-01 produced by Ishihara Sangyo Co., Ltd.) was used instead of 1 part by mass of the same.

### Example 18

A water-absorbing resin composition (E18) was obtained in the same manner as described in Example 2 except that 0.1 part by mass of photocatalytic titanium oxide (ST-01 produced by Ishihara Sangyo Co., Ltd.) was used instead of 1 part by mass of the same.

### Example 19

A water-absorbing resin composition (E19) was obtained in the same manner as described in Example 2 except that 2 parts by mass of photocatalytic titanium oxide (ST-01 produced by Ishihara Sangyo Co., Ltd.) was used instead of 1 part by mass of the same.

### Example 20

A water-absorbing resin composition (E20) was obtained in the same manner as described in Example 7 except that 0.1 part by mass of silica (AEROSIL200 produced by Nippon Aerosil Co., Ltd.) was used instead of 1 part by mass of the same.

### Example 21

A water-absorbing resin composition (E21) was obtained in the same manner as described in Example 7 except that 2 parts by mass of silica (AEROSIL200 produced by Nippon Aerosil Co., Ltd.) was used instead of 1 part by mass of the same.

### Example 22

100 parts by mass of the water-absorbing resin particle (A1) obtained in Manufacture Example 1 and 1 part by mass of photocatalytic titanium oxide (ST-01 produced by Ishihara Sangyo Co., Ltd.) were stirred in the stainless steel container. Then, 1 part by mass of water was added to this mixture, and this mixture was stirred and mixed adequately. Then, the obtained mixture was heat cured with an oven at 60° C. for an hour. Then, the obtained mixture was crushed, and then caused to pass through the JIS standard sieve whose mesh size was 600 μm. Thus, a water-absorbing resin composition (E22) was obtained.

### Example 23

A water-absorbing resin composition (E23) was obtained in the same manner as described in Example 22 except that 0.3 parts by mass of silica (AEROSIL200 produced by Nippon Aerosil Co., Ltd.) was used instead of photocatalytic titanium oxide (ST-01 produced by Ishihara Sangyo Co., Ltd.).

### Example 24

A water-absorbing resin composition (E24) was obtained in the same manner as described in Example 23 except that 1 part by mass of silica (AEROSIL200 produced by Nippon Aerosil Co., Ltd.) was used instead of 0.3 part by mass of the same.

### Example 25

1 part by mass of photocatalytic titanium oxide (ST-01 produced by Ishihara Sangyo Co., Ltd.) was mixed with 100 parts by mass of the water-absorbing resin particle (A1) obtained in Manufacture Example 1. Thus, a water-absorbing resin composition (E25) was obtained.

### Example 26

The water-absorbing resin particle (A1) obtained in Manufacture Example 1 was put into the quartz separable flask having the stainless steel stirring blade. While stirring this at 400 rpm, this was irradiated with ultraviolet rays (ultraviolet rays which contain the wavelength 200 nm to 400 nm and whose irradiation intensity measured with the ultraviolet rays integrating actinometer (produced by Ushio Inc., UIT250, Photoreceiver UVD-S254) was 65 kW/cm²) for five minutes from a position 9 cm distant from the exterior wall of the quartz separable flask. 100 parts by mass of the obtained ultraviolet rays treated water-absorbing resin was mixed with 1 part by mass of photocatalytic titanium oxide (ST-01 produced by Ishihara Sangyo Co., Ltd.). Then, 1 part by mass of water was added to this mixture, and the mixture was stirred and mixed adequately. Then, the obtained mixture was crushed, and then caused to pass through the JIS standard sieve whose mesh size was 600 μm. A water-absorbing resin composition (E26) was obtained.

### Example 27

The water-absorbing resin particle (A1) obtained in Manufacture Example 1 was put into the quartz separable flask having the stainless steel stirring blade. While stirring this at 400 rpm, this was irradiated with ultraviolet rays (ultraviolet rays which contain the wavelength 200 nm to 400 nm and whose irradiation intensity measured with the ultraviolet rays integrating actinometer (produced by Ushio Inc., UIT250, Photoreceiver UVD-S254) was 65 kW/cm²) for five minutes from a position 9 cm distant from the exterior wall of the quartz separable flask. 100 parts by mass of the obtained ultraviolet rays treated water-absorbing resin was mixed with 1 part by mass of silica (AEROSIL200 produced by Nippon Aerosil Co., Ltd.). Then, 1 part by mass of water was added to this mixture, and the mixture was stirred and mixed adequately. Then, the obtained mixture was crushed, and then caused to pass through the JIS standard sieve whose mesh size was 600 μm. Thus, a water-absorbing resin composition (E27) was obtained.

### Comparative Example 1

The water-absorbing resin particle (A1) obtained in Manufacture Example 1 was regarded as a comparative water-absorbing resin particle (C1).

### Comparative Example 2

The water-absorbing resin particle (A1) obtained in Manufacture Example 1 was put into the quartz separable flask having the stainless steel stirring blade. While stirring the water-absorbing resin particle (A1) at 400 rpm, the water-absorbing resin particle (A1) was irradiated with ultraviolet rays (ultraviolet rays which contain the wavelength 200 nm to 400 nm and whose irradiation intensity measured with the ultraviolet rays integrating actinometer (produced by Ushio Inc., UIT250, Photoreceiver UVD-S254) was 65 kW/cm²) for five minutes from a position 9 cm distant from the exterior wall of the quartz separable flask. After this irradiation, the composition was crushed, and then caused to pass through the JIS standard sieve whose mesh size was 600 μm. Thus, a comparative water-absorbing resin composition (C2) was obtained.

### Comparative Example 3

1 part by mass of water was added to the water-absorbing resin particle (A1) obtained in Manufacture Example 1, and this mixture was stirred and mixed adequately. Then, the obtained mixture was heat cured with the oven at 60° C. for an hour. The obtained composition was crushed, and then caused to pass through the JIS standard sieve whose mesh size was 600 μm. Thus, a comparative water-absorbing resin composition (C3) was obtained.

### Comparative Example 4

100 parts by mass of the water-absorbing resin particle (A1) obtained in Manufacture Example 1 and 2.5 parts by mass of photocatalytic titanium oxide (STS-21 produced by Ishihara Sangyo Co., Ltd.) slurry solution were stirred in the stainless steel container, and mixed adequately. Then, the mixture was heat cured with the oven at 60° C. for an hour, and the obtained composition was crushed, and then caused to pass through the JIS standard sieve whose mesh size was 600 μm. Thus, a comparative water-absorbing resin composition (C4) was obtained.

### Comparative Example 5

0.3 part by mass of silica (AEROSIL200 produced by Nippon Aerosil Co., Ltd.) was mixed with 100 parts by mass of the water-absorbing resin particle (A1) obtained in Manufacture Example 1. Thus, a comparative water-absorbing resin composition (C5) was obtained.

### Comparative Example 6

A comparative water-absorbing resin composition (C6) was obtained in the same manner as described in Comparative Example 5 except that 1 part by mass of silica (AEROSIL200 produced by Nippon Aerosil Co., Ltd.) was used instead of 0.3 part by mass of the same.

### Comparative Example 7

The water-absorbing resin particle (A1) obtained in Manufacture Example 1 was put into the quartz separable flask having the stainless steel stirring blade. While stirring this at 400 rpm, this was irradiated with ultraviolet rays (ultraviolet rays which contain the wavelength 200 nm to 400 nm and whose irradiation intensity measured with the ultraviolet rays integrating actinometer (produced by Ushio Inc., UIT250, Photoreceiver UVD-S254) was 65 kW/cm²) for five minutes from a position 9 cm distant from the exterior wall of the quartz separable flask. 100 parts by mass of the obtained ultraviolet rays treated water-absorbing resin was mixed with 1 part by mass of photocatalytic titanium oxide (ST-01 produced by Ishihara Sangyo Co., Ltd.). Thus, a comparative water-absorbing resin composition (C7) was obtained.

### Comparative Example 8

A comparative water-absorbing resin composition (C8) was obtained in the same manner as described in Comparative Example 7 except that 1 part by mass of silica (AEROSIL200 produced by Nippon Aerosil Co., Ltd.) was used instead of photocatalytic titanium oxide (ST-01 produced by Ishihara Sangyo Co., Ltd.).

### Comparative Example 9

The water-absorbing resin particle (A2) obtained in Manufacture Example 2 was regarded as a comparative water-absorbing resin particle (C9).

### CONCLUSION

Table 1 shows manufacturing conditions of each of Examples and Comparative Example explained above. In Table 1, an “Ultraviolet Rays Irradiation” column indicates a target which was irradiated with ultraviolet rays. A “Water Addition” column indicates (i) a timing of adding water (before the ultraviolet rays irradiation, after the ultraviolet rays irradiation, or no ultraviolet rays irradiation) and (ii) the amount of water added. Note that the inorganic fine particles were coating the surface of the water-absorbing resin, so that the soluble element and particle size of the water-absorbing resin composition were substantially the same as those of the water-absorbing resin.

Measurement Results

Table 2 shows results obtained by measuring the centrifuge retention capacity (CRC), the absorbency against pressure (AAP), the saline flow conductivity (SFC), and the liquid distribution velocity (LDV) of each of the water-absorbing resin compositions and the comparative water-absorbing resin compositions obtained in Examples and Comparative Examples.

TABLE 1
Comparison of Manufacturing Conditions

| | | Water-Absorbing | Inorganic Fine | Ultraviolet | |
|---|---|---|---|---|---|
| | | Resin | Particle, | Rays | Water Addition, |
| | | Composition/Particle | Part By Mass | Irradiation | Part By Mass |
| EXAMPLES | 1 | (E 1) | Titanium Oxide, 1.0 | Mixture | Before Irradiation, 1.0 |
| | 2 | (E 2) | Titanium Oxide, 1.0 | Mixture | — |
| | 3 | (E 3) | Titanium Oxide, 1.0 | Mixture | After Irradiation, 1.0 |
| | 4 | (E 4) | Titanium Oxide Slurry, 2.5 | Mixture | — |
| | 5 | (E 5) | Silica, 0.3 | Mixture | Before Irradiation, 1.0 |
| | 6 | (E 6) | Silica, 1.0 | Mixture | Before Irradiation, 1.0 |
| | 7 | (E 7) | Silica, 1.0 | Mixture | — |
| | 8 | (E 8) | Silica, 1.0 | Mixture | After Irradiation, 1.0 |
| | 9 | (E 9) | Titanium Oxide, 1.0 | Inorganic Particle | — |
| | 10 | (E 10) | Silica, 0.3 | Inorganic Particle | — |
| | 11 | (E 11) | Silica, 1.0 | Inorganic Particle | — |
| | 12 | (E 12) | Titanium Oxide, 1.0 | Inorganic Particle | After Irradiation, 1.0 |
| | 13 | (E 13) | Silica, 0.3 | Inorganic Particle | After Irradiation, 1.0 |
| | 14 | (E 14) | Silica, 1.0 | Inorganic Particle | After Irradiation, 1.0 |
| | 15 | (E 15) | Titanium Oxide, 0.5 | Mixture | — |
| | | | Silica, 0.5 | | |
| | 16 | (E 16) | Titanium Oxide, 0.5 | Inorganic Particle | — |
| | | | Silica, 0.5 | | |
| | 17 | (E 17) | Titanium Oxide, 0.3 | Mixture | — |
| | 18 | (E 18) | Titanium Oxide, 0.1 | Mixture | — |
| | 19 | (E 19) | Titanium Oxide, 2 | Mixture | — |
| | 20 | (E 20) | Silica, 0.1 | Mixture | — |
| | 21 | (E 21) | Silica, 2 | Mixture | — |
| | 22 | (E 22) | Titanium Oxide, 1.0 | — | No Irradiation, 1.0 |
| | 23 | (E 23) | Silica, 0.3 | — | No Irradiation, 1.0 |
| | 24 | (E 24) | Silica, 1.0 | — | No Irradiation, 1.0 |
| | 25 | (E 25) | Titanium Oxide, 1.0 | — | — |
| | 26 | (E 26) | Titanium Oxide, 1.0 | Resin Particle | After Irradiation, 1.0 |
| | 27 | (E 27) | Silica, 1.0 | Resin Particle | After Irradiation, 1.0 |
| COMPARATIVE | 1 | (C 1) | — | — | — |
| EXAMPLES | 2 | (C 2) | — | Resin Particle | — |
| | 3 | (C 3) | — | — | No Irradiation, 1.0 |
| | 4 | (C 4) | Titanium Oxide Slurry, 2.5 | — | — |
| | 5 | (C 5) | Silica, 0.3 | — | — |
| | 6 | (C 6) | Silica, 1.0 | — | — |
| | 7 | (C 7) | Titanium Oxide, 1.0 | Resin Particle | — |
| | 8 | (C 8) | Silica, 1.0 | Resin Particle | — |
| | 9 | (C 9) | — | — | — |

TABLE 2
Measurement Results

| | | Water-absorbing | | | | |
|---|---|---|---|---|---|---|
| | | Resin | CRC | AAP | SFC | LDV |
| | | Composition/Particle | g/g | g/g | ×10⁻⁷ · cm³ · s · g⁻¹ | mm/s |
| EXAMPLES | 1 | (E 1) | 23.6 | 20.7 | 180 | 3.33 |
| | 2 | (E 2) | — | — | — | 3.46 |
| | 3 | (E 3) | — | — | — | 3.80 |
| | 4 | (E 4) | 23.7 | 21.0 | 145 | 2.43 |
| | 5 | (E 5) | 23.9 | 23.2 | 180 | 3.39 |
| | 6 | (E 6) | 23.9 | 22.3 | 204 | 3.44 |
| | 7 | (E 7) | — | — | — | 3.09 |
| | 8 | (E 8) | — | — | — | 3.30 |
| | 9 | (E 9) | — | — | — | 3.01 |
| | 10 | (E 10) | — | — | — | 3.0 |
| | 11 | (E 11) | — | — | — | 2.9 |
| | 12 | (E 12) | — | — | — | 3.5 |
| | 13 | (E 13) | — | — | — | 3.4 |
| | 14 | (E 14) | — | — | — | 3.5 |
| | 15 | (E 15) | 23.0 | 22.4 | 195 | 3.5 |
| | 16 | (E 16) | 23.1 | 22.4 | 190 | 3.6 |
| | 17 | (E 17) | 23.6 | 20.5 | 185 | 3.4 |
| | 18 | (E 18) | 23.7 | 20.3 | 182 | 3.2 |
| | 19 | (E 19) | 23.1 | 19.4 | 190 | 3.6 |
| | 20 | (E 20) | 23.6 | 22.0 | 190 | 3.0 |
| | 21 | (E 21) | 23.2 | 19.8 | 205 | 3.3 |
| | 22 | (E 22) | 23.5 | 21.4 | 185 | 2.79 |
| | 23 | (E 23) | — | — | — | 2.74 |
| | 24 | (E 24) | 23.6 | 22.5 | 206 | 2.76 |
| | 25 | (E 25) | — | — | — | 2.65 |
| | 26 | (E 26) | — | — | — | 2.2 |
| | 27 | (E 27) | — | — | — | 2.3 |
| COMPARATIVE | 1 | (C 1) | 24.5 | 23.3 | 124 | 0.57 |
| EXAMPLES | 2 | (C 2) | — | — | — | 0.56 |
| | 3 | (C 3) | — | — | — | 0.54 |
| | 4 | (C 4) | — | — | — | 0.84 |
| | 5 | (C 5) | — | — | — | 1.85 |
| | 6 | (C 6) | — | — | — | 1.91 |
| | 7 | (C 7) | — | — | — | 1.44 |
| | 8 | (C 8) | — | — | — | 1.6 |
| | 9 | (C 9) | 26.8 | 24.5 | 81 | 1.27 |

Evaluation

(1) The CRC and AAP in each of Examples 1 to 22 and 24 were not so different from those in Comparative Example 1 that is the water-absorbing resin particle (A1). However, the SFC in each of Examples 1 to 22 and 24 was improved, and the LDV of each of Examples 1 to 22 and 24 was improved dramatically. Since the water-absorbing material such as the paper diaper needs the improvements of the SFC and the LDV more than the improvements of the CRC or the AAP, the water-absorbing resin composition (particle) of each of Examples 1 to 22 and 24 is suitable as the water-absorbing material such as the paper diaper.

Note that the improvement of the SFC is considered to depend on the existence of the inorganic fine particle, not relate to the ultraviolet rays irradiation.

Table 2 does not show measurement values of the CRC, the AAP, and the SFC of each of Examples 2, 3, 7 to 14, 23, and 25 to 27, but these measurement values may be similar to those of Examples 1, and 4 to 6.

(2) The LDV has improved when the mixture of a resin particle A and the inorganic fine particle B was irradiated with ultraviolet rays, as in Examples 1 to 8, 15, and 17 to 21. Moreover, the LDV has improved also when the inorganic fine particle B which had been irradiated with ultraviolet rays was mixed with the water-absorbing resin A (the water-absorbing resin particle (A1)), as in Examples 9 to 14, and 16.

(3) The LDV has hardly improved when the water-absorbing resin A (the water-absorbing resin particle (A1)) which had been irradiated with ultraviolet rays and the inorganic fine particle B which had not irradiated with ultraviolet rays were combined, as in Comparative Examples 7 and 8.

It is clear from the above (2) and (3) that the ultraviolet rays irradiation needs to be carried out with respect to the inorganic fine particle B. The ultraviolet rays irradiation changes the characteristics and natures of the inorganic fine particle B. As a result, the LDV among the water-absorbing performances of the water-absorbing resin composition improves specifically.

(4) It is also clear from the above-described results that the ultraviolet rays irradiation does not cause special changes, for improving the LDV, of the natures and characteristics of the water-absorbing resin A.

The fact that the ultraviolet rays irradiation with respect to the inorganic fine particle B has a technically significant meaning technically matches the fact that the CRC and AAP which are largely affected by internal characteristics of the water-absorbing resin A do not particularly improve.

(5) It is clear that the addition of water may improve the LDV.

### INDUSTRIAL APPLICABILITY

The water-absorbing resin composition of the present invention is useful as, for example, the water-absorbing material such as the paper diaper. When the water-absorbing material contacts, for example, the urine, it can rapidly absorb the liquid and diffuses it entirely. The present invention can provide, for example, the paper diaper whose water-absorbing performance is excellent and whose sense of use such as the feel of the paper diaper is also excellent.

1-9. (canceled)

10. A water-absorbing resin composition including a water-absorbing resin A and an inorganic fine particle B, and having a liquid distribution velocity (LDV) of 2.0 mm/s to 10 mm/s.

11. The water-absorbing resin composition as set forth in claim 10, wherein the inorganic fine particle B has been irradiated with ultraviolet rays.

12. The water-absorbing resin composition as set forth in claim 10, wherein the inorganic fine particle B is an inorganic metal oxide.

13. The water-absorbing resin composition as set forth in claim 12, wherein the inorganic fine particle B is a mixture of two or more kinds of inorganic metal oxides.

14. The water-absorbing resin composition as set forth in claim 13, wherein the mixture of two or more kinds of inorganic metal oxides is a mixture containing silica and titanium oxide.

15. A method for manufacturing a water-absorbing resin composition including a water-absorbing resin A and an inorganic fine particle B, and having a liquid distribution velocity (LDV) of 2.0 min/s to 10 min/s,
the method comprising the step of mixing a water-absorbing resin A and an inorganic fine particle B, which has been irradiated with ultraviolet rays, on condition that an amount of the inorganic fine particle B is from 0.01 part by weight to 10 parts by weight when an amount of the water-absorbing resin A is 100 parts by weight.

16. A method for manufacturing a water-absorbing resin composition including a water-absorbing resin A and an inorganic fine particle B, and having a liquid distribution velocity (LDV) of 2.0 min/s to 10 min/s,
the method comprising the steps of:
mixing a water-absorbing resin A and an inorganic fine particle B on condition that an amount of the inorganic fine particle B is from 0.01 part by weight to 10 parts by weight when an amount of the water-absorbing resin A is 100 parts by weight, to produce a mixture; and
irradiating the mixture of the water-absorbing resin A and the inorganic fine particulate B with ultraviolet rays.
